(19) United States
(12) Patent Application Publication
(10) Pub. No.: US 2002/0196147 A1
(43) Pub. Date: Dec. 26, 2002

(54) Monitoring and tracking system

(76) Inventor: William Lau, Vancover (CA)

Correspondence Address: D. Scott Hemingway, Law Offices of D. Scott Hemingway, Preston Commons West, Suite 800, 8117 Preston Rd., Dallas, TX, 75225, US

(21) Appl. No.: 09/886,632

(22) Filed: Jun. 21, 2001

(51) Int. Cl. G08B 23/00

(52) U.S. Cl. 340/573.1; 340/531; 340/541; 348/152

(57) ABSTRACT

A monitoring and tracking system utilizing the Internet to maintain a website database. The website database will include a listing or graphical representation of the location of one or more data-emitting devices and the identity or location of the data-receiving devices. By accessing an website database, a subscriber can view the present and/or past location of a monitored subject. The system can also incorporate an alarm feature that activates when a monitored subject enters a prohibited area, leaves a specified area, or fails to receive a transmission at a specified time. A camera may be associated with the data-receiving device transmitting an associated image to the website.

### TECHNICAL FIELD OF THE INVENTION

A monitoring and tracing system, and a method for performing monitoring and tracking.

### BACKGROUND OF THE INVENTION

A number of situations call for the capability of a person to locate and track individuals from a remote location. These situations include location and tracking for: (1) private recreational activities such as tracking of golfers and golf carts on a golf course, (2) private individual concerns such as the locating children and pets in a local area, or (3) governmental needs such as monitoring the whereabouts of prisoners or parolees. Prior art remote location and tracking systems have been limited by the constraints of a land-based telephone system or required a Global Positioning satellite infrastructure. Using some of the technological innovations supported by the Internet and wireless communication technology (or similar technologies), a new system and method for monitoring and tracking is possible that would provide significant benefits over the known art technologies.

Remote Location and Detection Systems

Prior art methods of monitoring and location detection have employed various systems and methods. For instance, U.S. Pat No. 6,169,484 to Schuchman discloses a personal location system that has a service center, which is contacted over a land-based telephone link. In Schuchman, a broadcast signal is transmitted to a receiver device on a land-based telephone line, and the receiver must make a communication to a manned service center. The service center receives the information from the land-based telephone call and responds appropriately to location and tracking inquiries.

U.S. Pat No. 5,363,425 to Sohale also discloses a locator system for locating individuals or equipment on an in-building telephone network. The invention uses the land-based phone system of a building to track an individual or equipment based upon the location of an identification badge. Telephone calls on the land-based system can be forwarded to an individual based upon the detected location of that individual.

U.S. Pat. No. 6,072,396 to Gaukel discloses a more advanced electronic monitoring system using the Global Positioning System (“GPS”) satellites. The location and detection of equipment is determined through the use of satellite signals and a GPS location scheme. Overall, these prior art systems are believed to possess significant limitations that are overcome by the present invention.

The Internet

The Internet, like so many other recent developments, grew from research originally performed for the United States Department of Defense. In the 1960s, Defense Department officials began to notice that the military was accumulating a large collection of computer systems—some of which were connected to open computer networks and others that were connected to closed computer networks. Computers on the Defense Department's open computer networks, however, could not communicate with the military's closed network computers.

Defense Department officials requested that a system be built to permit communication between these different computer networks. The Defense Department recognized, however, that a single centralized system would be vulnerable to missile attacks or sabotage. Accordingly, the Defense Department required that the interface system be decentralized so that no critical services would be concentrated in vulnerable failure points. In order to achieve these goals, the Defense Department established a decentralized standard protocol for communication between network computers.

A few years later, the National Science Foundation (NSF) wanted to connect network computers at various research institutions across the country. The Defense Department's interface system communication protocol was called the Internet Protocol (IP) standard. The NSF adopted the Defense Department's protocol for communication, and this combination of research computer networks would eventually evolve into the Internet.

The IP standard, as subsequently adopted by the NSF, now supports communications between computers and networks on the Internet. The IP standard identifies the types of services to be provided to users, and specifies the mechanisms needed to support these services. The IP standard also describes the upper and lower system interfaces, defines the services to be provided on these interfaces, and outlines the execution environment for services needed in the system.

A transmission protocol, called the Transmission Control Protocol (TCP), was also developed to provide connection-oriented, end-to-end data transmission between packet-switched computer networks. The combination of the TCP protocol with IP (TCP/IP) forms a system or suite of protocols for data transfer and communication between computers on the Internet. The TCP/IP standard has become mandatory for use in all packet switching networks that connect computers across network or sub-network boundaries. Protocols similar to the TCP protocol can be used to control end-to-end communications.

TCP/IP and its related protocols form a standardized system for defining how IP based data packets should be processed, transmitted, and received on the Internet. Wireless and wired communications systems are increasingly integrating packet data transfer technology into their systems based on the TCP/IP protocols. The Internet and various packet-based communication systems, however, do not presently support a comprehensive and readily accessible system for monitoring and tracking objects and/or individuals. Accordingly, there is believed to be a need for remote location and detection system that has a user accessible database.

### SUMMARY OF THE INVENTION

The invention is a system and method for monitoring and tracking a subject or object within a local vicinity. The subject being monitored wears a data-emitting device that emits a low-power radio signal with an address uniquely identifying the data-emitting device. A data-receiving device located in the local vicinity of the data-emitting device receives the low-power radio signal and transmits information regarding the location of the data-emitting device to a database. The database is linked to the data-receiving device, and the database supports a user-accessible website.

The present invention uses the advances achieved from wireless communication technology and the Internet, or any similar type of communications network, as a backbone for the transmission and retrieval of location information. When a subscriber accesses the user accessible website, the website will display the present location of the monitored subject, the location of the monitored subject over a period of time, and at times, the image of the monitored subject in the local vicinity.

### BRIEF DESCRIPTION OF THE DRAWINGS

The objects and features of the invention will become more readily understood from the following detailed description and appended claims when read in conjunction with the accompanying drawings in which like numerals represent like elements and in which:

FIG. 1 is a representation for the present monitoring and tracking system with a direct connection to the Internet;

FIG. 2 is a general Type-Length-Data extension format used in the TCP/IP protocol;

FIG. 3 is general representation of an Internet data packet used in the TCP/IP protocol;

FIG. 4 a representation of the present monitoring and tracking system with a connection to a centralized monitoring computer; and

FIG. 5 is a representation of the present monitoring and tracking system with a monitoring camera system.

### DETAILED DESCRIPTION OF THE PREFERRED EMBODIMENTS

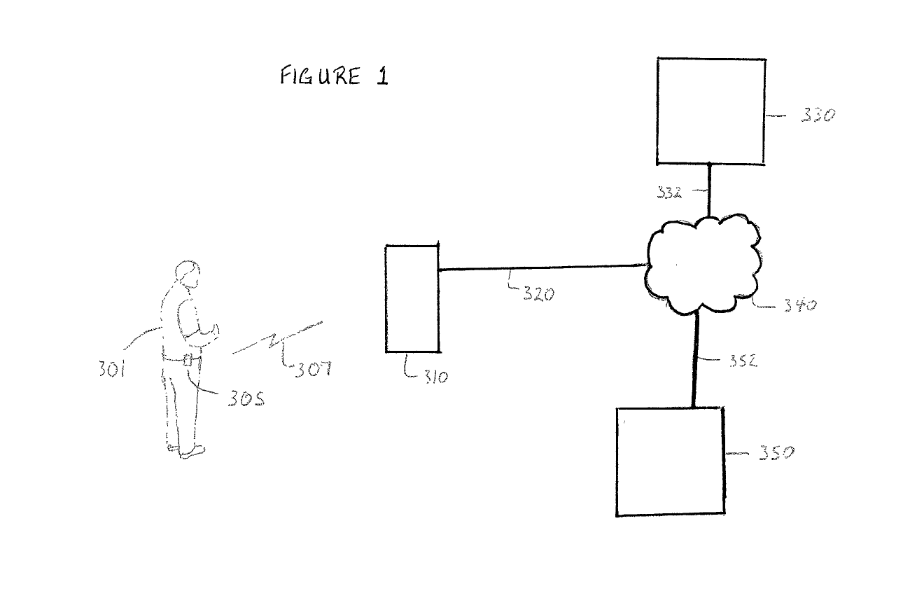

FIG. 1 shows one embodiment of the present invention with a user 301 having a Data Emitting Device (DED) 305. The DED 305 is linked via a wireless communication signal 307 to a Data Receiving Device (DRD) 310. DRD 310 has sufficient computational power to transmit and receive messages, and DRD 310 is coupled to the Internet 340 via communication link 320. A Monitoring Website Server Computer (MWS) 350 is coupled to the Internet 340 via communication link 352, and a user computer 330 is shown coupled through communication link 332.

The DED 305 periodically emits a low-power Address Identifying Signal (AIS) that is transmitted over wireless communication link 307. The time interval for AIS transmission is variable as specified by the system, but the recommended interval between transmissions is between five and fifteen minutes. In an alternative embodiment, the AIS transmission may also be transmitted in response to an initiating signal from the DRD 310 or other initiating device.

The AIS is received through communication link 307 by DRD 310 for processing. The AIS transmission includes address information for the DED 305, and the DRD 310 combines the DED 305 address information from AIS with other information, including the DRD 310 location and time, to form an information packet.

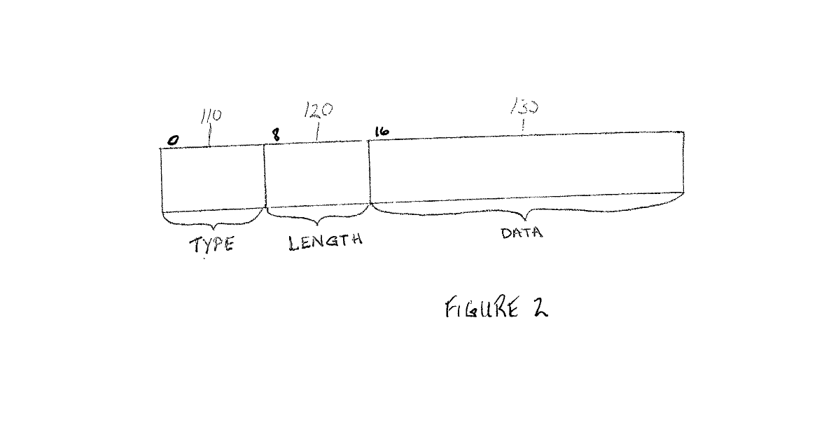

The packet structure shown in FIG. 2 is a general format base information used in the present invention. The base information is in Type-Length-Data (TLD) format. The Type variable 110 (designated by “T”) occupies the first 8 bits of the general extension, the Length variable 120 (designated by “L”) occupies the next 8 bits of the general extension, and the Data variable 130 (designated by “D”) occupies the remaining bits in the general extension based upon the data content (type and length). The Type variable 110 indicates the particular type of packet found therein, and the Length variable 120 indicates the length in bytes of the data field within the extension. The Data field 130 may be zero or more bytes in length, and sets forth the applicable data that is being transmitted.

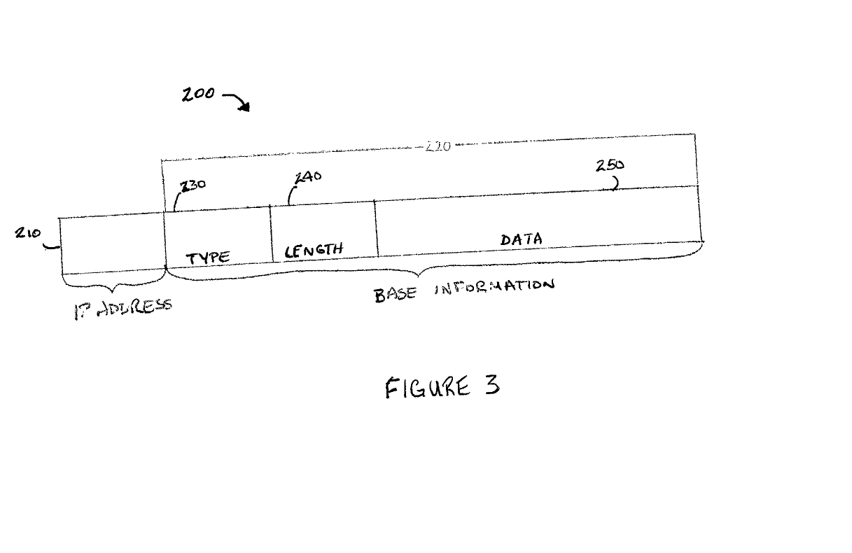

For information packet 200 transmissions from the DRD 310 to MWS 350, an information data packet 200 is routed using an appended IP destination address of the MWS 350 as shown in FIG. 3. In FIG. 1, the DRD 310 receives the AIS on communication link 307 from the DED 305. The DRD 310 then sends an information packet 200 with the address of the DED 305 and identifying information of the DRD 310 to the MWS 350. The address of the DED 305 and identifying information of the DRD 310 are located within the data packet data element 130.

The DRD 310 identifier can be a specific address identifying number, a street address, a name for the location, user name, or some other specific location designation. The IP Address 210 is appended onto the base information 220. The IP Address 210 contains a source (DRD 310) and destination (MWS 350) addresses in accordance with the established protocols. The base information 220 consists of a type variable 230, length variable 240, and data variable 250 format described above in FIG. 2. Using the appended IP addressing 210, information packets are routed from the DRD 310 along communication line 320 to the Internet 340, and then from the Internet 340 to MWS 350 via communication links 352. Alternatively, the MWS 350 can be coupled directly to the DRD 310 without an intermediate communication link through the Internet 340.

The MWS 350 receives, processes, and stores the information in the information packet 200 on an organized website database. The website database will include historical location information such as the present and past location of the DED 305 in relation to the DRD 310 over a predetermined time period. Present and historical location information for other DEDs and DRDs can also be maintained on the website database. The website database will also maintain times and duration periods of presence or absence of DED 305 from the local vicinity serviced by the DRD 310. Alternatively, the user computer 330 may be directly coupled to the MWS 350 without an intermediate communication link through the Internet 340.

A subscriber using the monitoring and tracking system will use computer 330 to communicate with the MWS 350. The subscriber can log onto the website database located at the MWS 350 in order to access location information maintained on the website database on MWS 350. When the user computer is coupled to the MWS 350 website database, the website will indicate the present and past location of the DED 305 relative to the vicinity of the DRD 310.

The subscriber can issue an inquiry to the website database regarding single monitored subject 301 using DED 305. The NWS 350 will communicate with the subscriber's computer 330 by sending information on the requested subject 301. In the preferred embodiment, the website database on MWS 350 can provide the subscriber with the current or last location of a designated monitored subject 301 using DED 305, the time of the last data transmission from the DED 305, and a listing of all the locations and time entries for the monitored subject 301 over a subscriber specified period (e.g. 12 hours, 24 hours, etc.). The website could also show a map of these locations where the DED is or has been found for a predetermined time period.

While only one DED and DRD are shown in FIG. 1, any number of DEDs can be used to monitor multiple subjects and any number of DRDs can be used in the system to extend the local vicinity coverage of the monitoring and tracking system. Each DRD can have a direct connection to the Internet 340. When accessing the monitoring database, the subscriber can request location information on multiple DEDs or an entire group of DEDs.

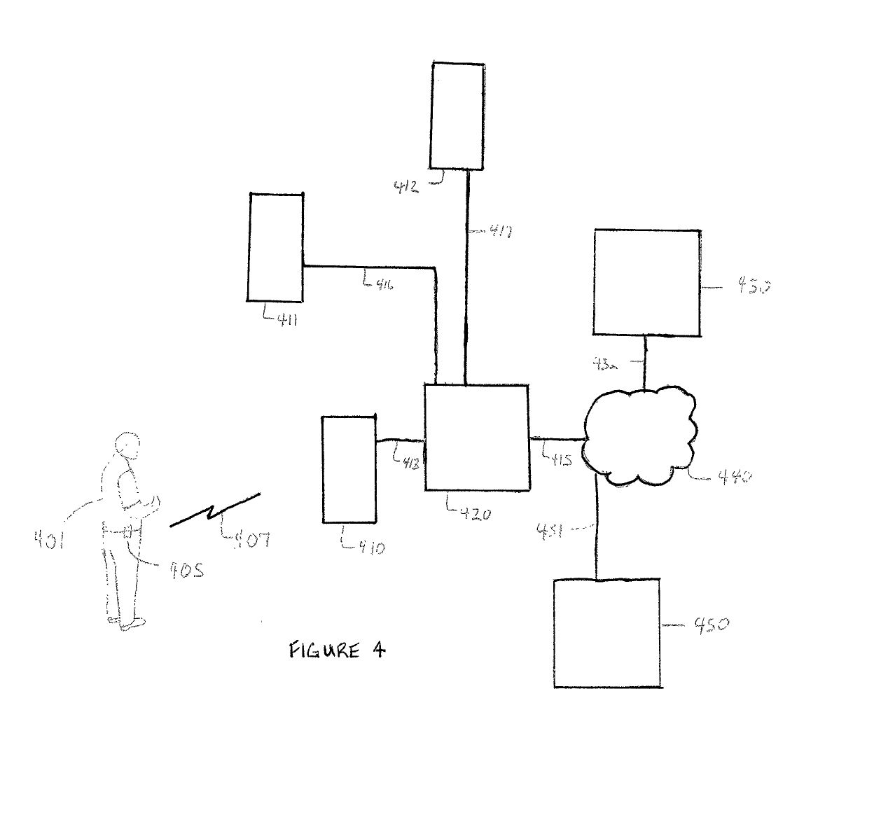

FIG. 4 shows an alternative embodiment where a plurality of DRDs are linked to a monitoring computers 420. In this embodiment, the DED 405 associated with the individual 401 is coupled to DRD 410 by wireless link 407. The DED 405 is capable of transmitting an AIS to DRD 410 on the system or any other DRD on the system. While only one DED is shown in FIG. 4, any number of DEDs can be used to monitor multiple subjects in the local vicinity covered by DRD₁ 410 and its companion DRDs.

Each DRD can have a direct connection to the Internet 340. DRD₁ 410 is coupled to computer₁ 420 via communication link 413, DRD₂ 411 is coupled to computer₁ 420 via communication link 416, and DRD₃ 412 is coupled to computer₁ 420 via communication link 417. Computer₁ 420 is coupled to the Internet 440 via communication link 415, and a MWS 450 is linked to the Internet 440 via communication link 451. A user computer₂ 430 can be coupled to the MWS 450 via communication link 432 to the Internet 440 and then communication link 451 to MWS 450.

In FIG. 4, the monitored subject 401 has a DED 405 that emits a periodic AIS on the wireless communication link 407. The time interval for AIS transmission is variable as specified by the system, but the recommended interval between transmissions is between five and fifteen minutes. In an alternative embodiment, the AIS transmission may also be transmitted in response to an initiating signal from the DRD 410 or other initiating device.

DRD₁ 410 receives the AIS on communication link 407 and processes the identification and address information on the AIS. The AIS transmission includes address information for the DED 405, and the DRD 410 combines the DED 405 address information from AIS with other information, including the DRD 410 address location and time, to form an information packet 200 as described in FIG. 3. After forming this information packet 200, the DRD₁ 410 transmits the information packet 200 to the monitoring computer₁ 420 by communication link 413.

The DRDs that are connected to the monitoring computer₁ 420 include DRD₁ 410, DRD₂ 411, and DRD₃ 412. The monitoring computers₁ 420 can process the information packet 200 as received from each DRD on the local network. New source and destination addressing information will need to be appended to the information packet 200 before the monitoring computer₁ 420 can transmit the information packet 200 to the MWS 450. After receipt of the information packet 200, the monitoring computer₁ 420 transmits the information packet 200 to MWS 450. The monitoring computer₁ 420 transmits the information packet 200 by communication link 415 to the Internet 440 and the packet is transmitted to the MWS 450 via communication link 451 to MWS 451.

A website database as previously described is maintained on the MWS 450 for posting current and historical location information. A subscriber can access the website database using the computer₂ 430. The computer₂ 430 establishes a connection with the website by logging onto the MWS 450 website database, and then transmitting a request inquiry to the website database. The log-on request and request inquiry are transmitted on communication link 431 through the Internet 440, and then to MWS 450 on communication link 451. The MWS 450 responds to the computer₂ 430 with responsive location and tracking information.

As described in the present invention, the AIS signal may be transmitted in response to an initiation or inquiry signal. This inquiry signal can be issued to determine if a particular DED is in the vicinity of a particular DRD. If not located at a particular DRD, a wider broadcast of an initiation or inquiry signal can be transmitted to all DRDs in a broader region. If not located from this broadcast, all DRDs in the system can receive an initiation or inquiry signal to determine the location of the DED. Such broadcast inquiry signals can also be issued periodically with respect to all DRDs on the system as a means to address and update the entire system with respect to the locations of all DEDs. This broadcast inquiry could originate from the MWS 450, the computer₂ 430, or the computer₁ 420. The broadcast inquiry could also be issued as an autonomous feature of the DRDs on the system. The location functionality could even be an overlay to a local pager or cellular telephone system, where a message is transmitted from the DEDs to a cellular base station unit.

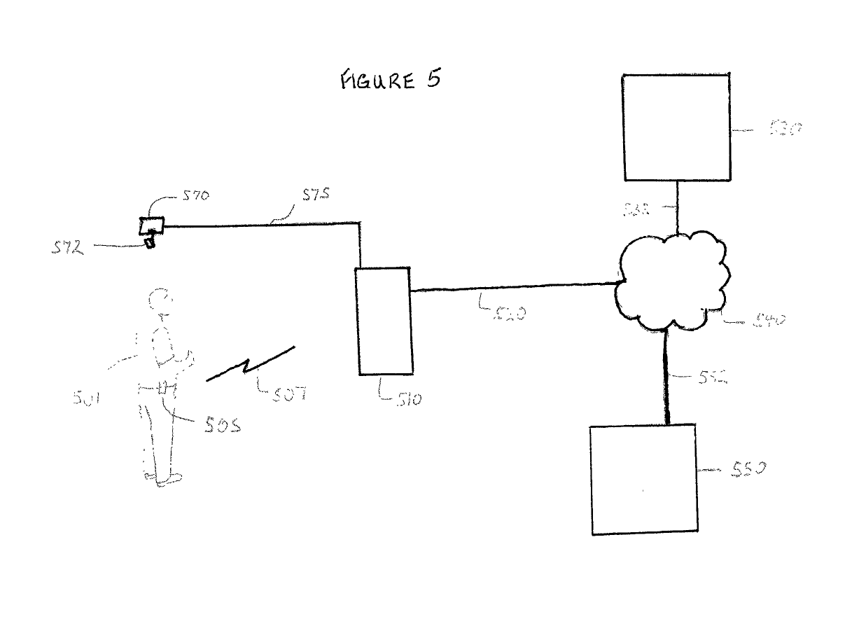

FIG. 5 shows an alternative embodiment of the present invention with a camera system 570 coupled to DRD 510 via communication link 575. The DRD 510 is coupled to the Internet 520 via communication link 520, and an MWS 550 is connected to the Internet 540 by communication link 540. A user computer 530 is connected to the Internet 540 by communication link 532.

In this embodiment, the DED 505 worn by individual 501 transmits an AIS to DRD 510 over wireless signal 507. DRD 510 has a direct connection to the Internet 540 via communication link 520. The present embodiment can also be used with the monitoring computer embodiment shown in FIG. 4.

DRD 510 is linked to a camera system 570 that includes a camera 572 that can be set up in either a fixed position or to “pan” a location. The camera 572 could pan a location continuously as part of a visual recording system 570, the camera 572 could be fixed, or the camera 572 could respond to movement command inputs over communication link 575 from DRD 510. The camera system 570 could also take a single image or take serial digital images over a predetermined period of time. In this embodiment, an image obtained by the camera system 570 would be transmitted to DRD 510 via by communication link 575.

In FIG. 5, the DRD 510 would receive the visual data from the camera system 570. DRD 510 would process the visual data for transmission to the MWS 550. The information packet 200 would be prepared as described above with the visual data received from the camera system 572 or the address, location and time data received from the DED 505. The information packet 200 would be transmitted to the Internet 540 over communication link 520, and the information packet 200 would then be transmitted over communication link 552 to the MWS 550.

The information packet 200 received by MWS 550 would be processed and maintained on the website database supported by MWS 550. The website database, as described above, would be assessable to users of the computer 520 through the communication link 532 to the Internet 540 and communication link 552 to the MWS 550. In this manner, a website database offers a video image of the monitored subject 501 at the location covered by DRD 510 to system users. The DEDs and DRDs described in the prior embodiments can be used in this embodiment as well.

With respect to another alternative embodiment, all the prior systems could incorporate an alarm or notification system where the DRD last associated with a DED would notify the MWS or monitoring computer upon the loss of communication with a DED. DEDs could also be assigned regions of acceptable and unacceptable DRD vicinities, and if communication with the DED is lost or the DED is located in an unacceptable vicinity, an alarm may be activated to alert the proper personnel of the situation. The alarm situation may necessitate immediate action, or simply necessitate a recording of each violation of acceptable vicinity location or loss of communication with the DED.

The invention can be used in numerous applications where a subscriber wishes to monitor one or more subjects or objects. In one application, the present invention could be set up in a neighborhood (e.g. school, community center, neighbors, shops, mall, etc.) to monitor children. Parents could access the monitoring website and determine where their child is or has been. In another application, the present invention could be used at a day care center to monitor location of children and initiate an alarm if the child is abducted or wanders away from the facility. A similar application could be used in a nursing home for elderly residents.

The device could also be used in large warehouses or other workplaces to locate and track employees or equipment (e.g. forklifts). Golf courses could also use the system to track golf parties or carts along the course. Another application of the present invention could include a prison setting where each inmate has an assigned DED, and the invention could initiate an alarm if an inmate attempts to enter an unauthorized area or leaves an authorized area without permission. The alarm could initiate a locking command to secure exits from a vicinity. Similarly, in another embodiment, the invention could be used in a home to monitor parolees. If the parolee leaves the home or an authorized area, the system could send an alert to a monitoring computer or sound an alarm. A camera could also be used to monitor the parolee's activities.

While the invention has been particularly shown and described with respect to preferred embodiments, it will be readily understood that minor changes in the details of the invention may be made without departing from the spirit of the invention.

Having described the invention, we claim:

1. A monitoring system comprising:
at least one data-emitting device that transmits information packets having address information for said data-emitting device;
at least one data-receiving device located in a local area having an address identifier and capable of receiving an address information signal from said data-emitting device;
a monitoring computer server linked to the data-receiving device, said data-receiving device transmitting address information to said monitoring computer server for maintenance on a database.

2. The monitoring system of claim 1 wherein the database of the monitoring computer server stores information including the address of the data-emitting device, the location of the data-receiving device, and a time data element.

3. The monitoring system of claim 1 further comprising an alarm system initiated upon a predetermined condition.

4. The monitoring system of claim 1 further comprising a camera associated with the data-receiving device that captures a visual image for a particular vicinity.

5. The monitoring system of claim 4 wherein visual data is transmitted to the monitoring computer server.

6. The monitoring system of claim 4 wherein the visual data transmitted to the monitoring computer server can be maintained on the database of the monitoring computer server.

7. A method for monitoring presence comprising the steps of:
providing a data-emitting device having an address identifier associated therewith;
transmitting said address identifier information from the data-emitting device to a data-receiving device;
transmitting address identifier information received at the data-receiving device to a server computer; and
processing the address identifier information received at the server computer for maintenance of a presence database.

8. The method for monitoring presence of claim 7 further comprising an alarm mechanism that is activated upon a predetermined condition.

9. The method for monitoring presence of claim 7 further comprising an alarm mechanism that is activated in the absence of detecting a data-emitting device in a predetermined vicinity.

10. The method for monitoring presence of claim 7 further comprising accessing the address information maintained on the user database.

11. The method for monitoring presence of claim 7 further comprising the step of capturing an image of a vicinity with a camera system.

12. The method for monitoring presence of claim 11 further comprising the step of transmitting visual data to the server computer.

13. The monitoring system presence of claim 7 wherein the server computer has a database of the presence data transmitted by the data-receiving device.

14. The monitoring system presence of claim 13 further comprising the step of maintaining a visual image that can be assessed on the presence database.

15. The monitoring system presence of claim 13 wherein the database maintains information on the address of the data-emitting device, the address of the data-receiving device, and a time data element.

16. The monitoring system presence of claim 15 wherein the database maintains the times when the data-emitting device is absent from a predetermined vicinity.

17. A monitoring system comprising:
said at least one data-emitting device transmitting an identifying data element to a data-receiving device for processing by the data-receiving device,
a first monitoring computer coupled to said data-receiving device and being capable of receiving identifying data elements from said data-receiving device,
a server computer coupled to said first monitoring computer, said server computer being capable of receiving said identifying data elements from said first monitoring computer and maintaining a user-accessible database with information on the presence and location of data-emitting devices.

18. The monitoring system of claim 17 wherein said at least one data-emitting device will activate an alarm under a predetermined condition.

19. The monitoring system of claim 17 wherein said at least one data-receiving device that will activate a locking mechanism under a predetermined condition.

20. The monitoring system of claim 17 further comprising:
an imaging device that is coupled to the server computer.
